(19) United States
(12) Patent Application Publication
(10) Pub. No.: US 2010/0126323 A1
(43) Pub. Date: May 27, 2010

(54) BLIND CUTTER

(76) Inventor: Chin-Fu CHEN, Taichung (TW)

Correspondence Address: BROWDY AND NEIMARK, P.L.L.C.;624 NINTH STREET, NW, SUITE 300, WASHINGTON, DC, 20001-5303, US

(21) Appl. No.: 12/359,883

(22) Filed: Jan. 26, 2009

(30) Foreign Application Priority Data
Nov. 25, 2008 (TW) 97145577

(51) Int. Cl. B26D 1/00; B26D 7/02

(52) U.S. Cl. 83/197; 83/454

(57) ABSTRACT

A blind cutter includes a base, a rail obliquely mounted to the base, a slide block slidably mounted to the rail and slidable between a first position and a second position that is lower than the first position, and a saw blade rotatably connected with the slide block. As a result, when a user pushes the slide block from the second position to the first position for cutting slats of a blind, the saw blade and the slide block can move back to the second position automatically because of gravity when the cutting action of the saw blade has been finished.

### BACKGROUND OF THE INVENTION

1. Field of the Invention

The present invention relates generally to a blind cutter for cutting a blind, and more specifically to a blind cutter that includes a saw blade capable of moving back to an initial position automatically when finishing the cutting action.

2. Description of the Related Art

U.S. Pat. No. 6,336,388 discloses a blind cut down machine, comprising a base, a rail mounted to the base, a block slidably mounted to the rail, a saw blade rotatably connected with the block and driven by an electric motor for cutting slats of a blind, a fixed plate fixed to the base, and a movable plate movably mounted to the base and carrying a cutting die for cutting a head rail of the blind. By means of the aforesaid design, a user can fasten the slats and the head rail of the blind to the base, and then move the saw blade and the movable plate to cut the slats and the head rail of the blind.

However, when the cutting action of the blind cut down machine has been finished, the user needs to force the saw blade to move back to an initial position by manual operation or using a pneumatic cylinder, resulting in that the blind cut-down apparatus has the drawback of inconvenient operation.

### SUMMARY OF THE INVENTION

The present invention has been accomplished in view of the above-noted circumstances. It is one objective of the present invention to provide a blind cutter, which has a saw blade that can move back to an initial position automatically when finishing the cutting action.

To achieve this objective of the present invention, the blind cutter comprises a base having a first through hole and a second through hole, a first rail mounted to the base, a slide block slidably mounted to the first rail and being slidable between a first position and a second position that is lower than the first position, a saw blade rotatably connected with the slide block and covering the first through hole when the slide block is located at the first position, a motor connected with the saw blade, a fixed cutting blade fixed to the base, and a movable cutting blade movably mounted to the base and abutted against the fixed cutting blade.

In an embodiment of the present invention, the blind cutter further comprising a regulation plate movably mounted to the slide block, a transmission rod including a shaft portion inserted into a circular hole of the fixed cutting blade, and a cam portion inserted into an eccentric hole of the movable cutting blade, a handle connected with the shaft portion of the transmission rod, a screw rotatably mounted to the base, and a clamp member engaged with the screw to be movable relative to the first through hole of the base. Further, the fixed cutting blade and the movable cutting blade are respectively provided with a cutting hole that is communicated with the second through hole of the base, and clamped between two guide plates of a second rail.

Accordingly, when a user pushes the slide block from the second position to the first position, the saw blade and the slide block can move back to the second position automatically because of gravity when the cutting action of the saw blade has been finished.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a perspective view of a blind cutter according to a first preferred embodiment of the present invention, showing the front side of the blind cutter.

FIG. 2 is another perspective view of the blind cutter according to the first preferred embodiment of the present invention, showing the rear side of the blind cutter;

FIG. 3 is an exploded view of the blind cutter according to the first preferred embodiment of the present invention;

FIG. 4 is a front view of the blind cutter according to the first preferred embodiment of the present invention, showing the slide block located at the second position;

FIG. 5 is similar to FIG. 4, but showing the slide block located at the first position;

FIG. 6 is a perspective view of the blind cutter according to a second preferred embodiment of the present invention;

FIG. 7 is a perspective view of the fixed cutting blade and the movable cutting blade of the blind cutter according to the preferred embodiment of the present invention, showing another type of the fixed cutting blade and the movable cutting blade provided, and

FIG. 8 is a perspective view of the fixed cutting blade and the movable cutting blade of the blind cutter according to the preferred embodiment of the present invention, showing still another type of the fixed cutting blade and the movable cutting blade provided.

### DETAILED DESCRIPTION OF THE INVENTION

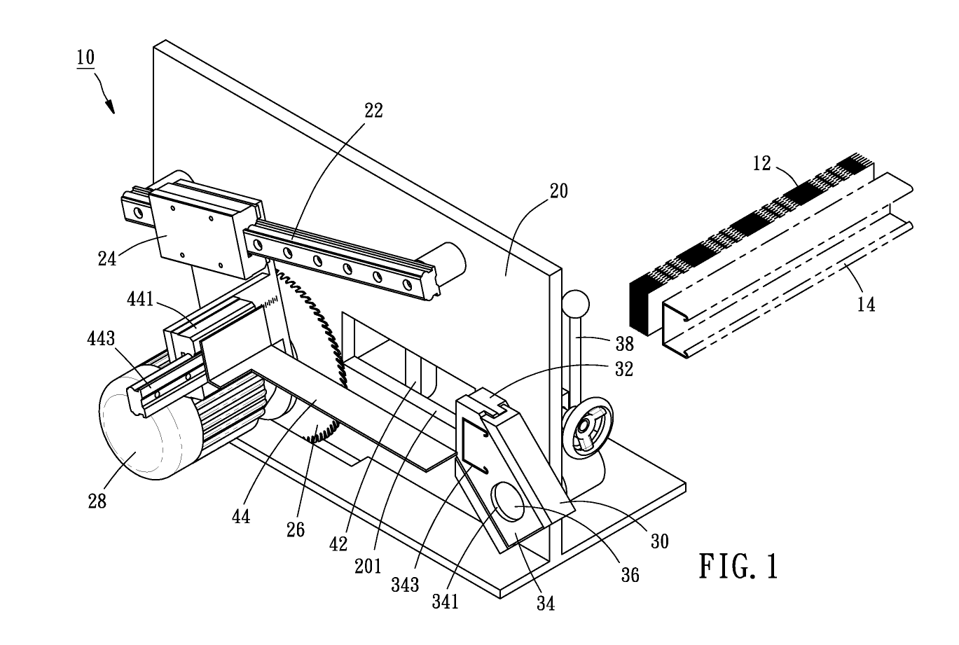

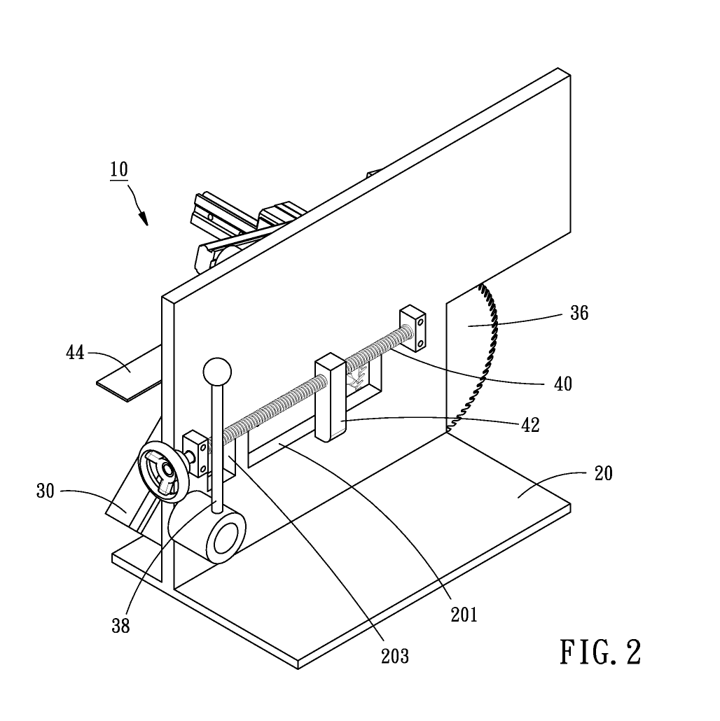

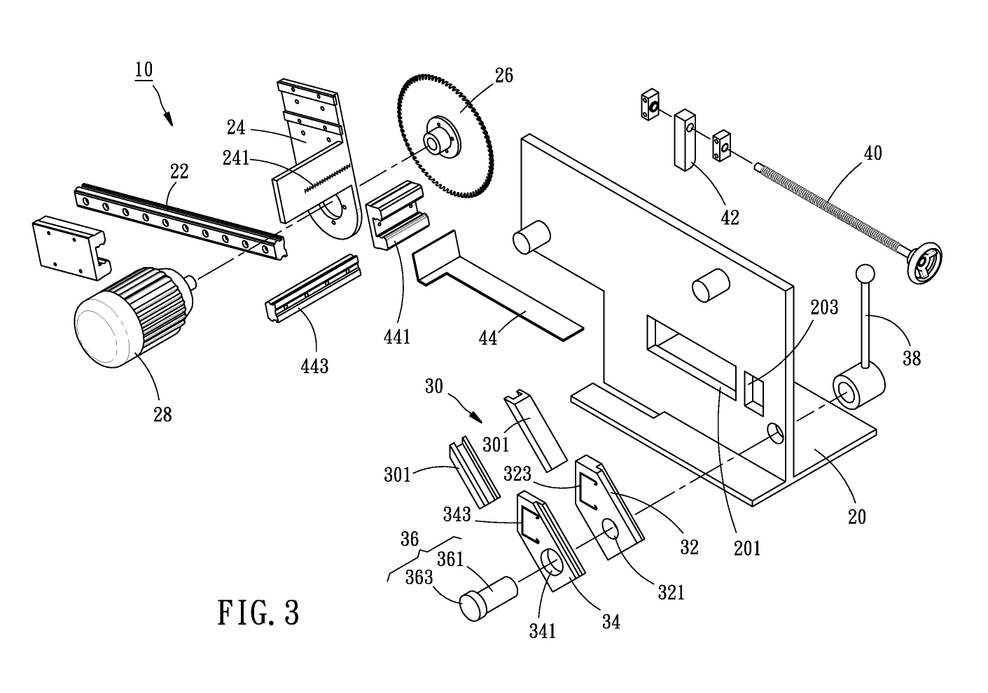

As shown in FIGS. 1 to 4, a blind cutter 10 for cutting slats 12 and a head rail 14 of a blind in accordance with a first preferred embodiment of the present invention comprises a base 20, a first rail 22, a slide block 24, a saw blade 26, a motor 28, a second rail 30, a fixed cutting blade 32, a movable cutting blade 34, a transmission rod 36, a handle 38, a screw 40, a clamp member 42, and a regulation plate 44.

The base 20 has a rectangular first through hole 201 for penetration of the slats 12, and a rectangular second through hole 203 for penetration of the head rail 14.

The first rail 22 is obliquely mounted to the front side of the base 20.

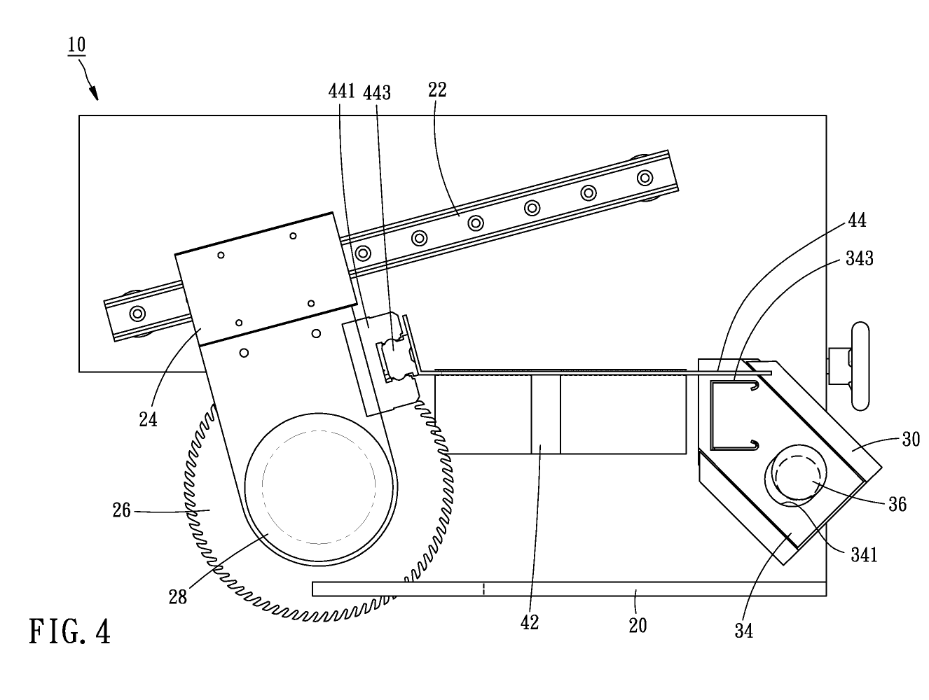

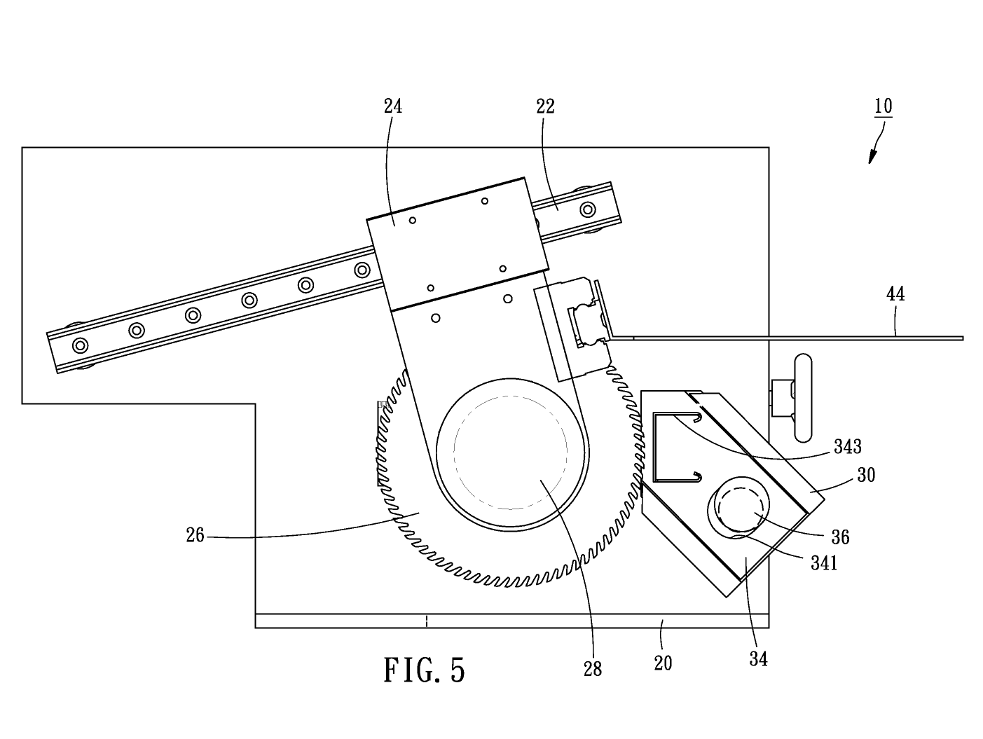

The slide block 24 is configured to the first rail 22 and slidable between a first position, as show in FIG. 5, and a second position, as shown in FIGS. 1 and 4. The first position is higher than the second position.

The saw blade 26 is rotatably connected with the slide block 24. When the slide block 24 is moved from the second position to the first position, the saw blade 26 can gradually cover the first through hole 201 and cut the slats 12 passing through the first hole 201.

The motor 28 is mounted to the slide block 24 and connected with the saw blade 26 for driving the saw blade 26 to rotate.

The second rail 30 includes two guide plates 301, each of which has a U-shaped section.

The fixed cutting blade 32 is clamped between the guide plates 301 of the second rail 30, and provided with a circular hole 321 at a bottom side thereof and a cutting hole 323 at a top side thereof. The cutting hole 323 is U-shaped and communicated with the second through hole 203 of the base 20 for penetration of the head rail 14.

The movable cutting blade 34 is clamped between the guide plates 301 of the second rail 30, and moveable relative to the guide plates 301, and abutted against the fixed cutting blade 32. The movable cutting hole 34 includes an eccentric hole 341 and a cutting hole 343 that has the same dimensions and position as the cutting hole 323 of the fixed cutting blade 32. When the head rail 14 passes through the cutting holes 323, 343, the head rail 14 can be cut by means of the relative movement of the fixed cutting blade 32 and the movable cutting blade 34.

The transmission rod 36 passes through the eccentric hole 341 of the movable cutting blade 34, the circular hole 321 of the fixed cutting blade 32, and the base 20 in such a way that a shaft portion 361 of the transmission rod 36 is inserted into the circular hole 321, and a cam portion 363 of the transmission rod 36 is inserted into the eccentric hole 341 such that the movable cutting blade 34 can be forced to move along the second rail 30 by the rotation of the cam portion 363 when the shaft portion 361 is rotated.

The handle 38 is connected with the shaft portion 361 of the transmission rod 36 for driving the transmission rod 36 to rotate.

The screw 40 is rotatably mounted to the rear side of the base 20.

The clamp member 42 is abutted against the base 20 and engaged with the screw 40 to be movable relative to the first through hole 301 for enabling the slats 12 to be clamped between the clamp member 42 and a periphery wall of the first through hole 301, thereby keeping the slats 12 stationary.

The regulation plate 44 is configured to the slide block 24 through a third rail 441 and a movable member 443 so as to be movable relative to the slide block 24. The regulation plate 44 is abutted against a distal end of the slats 12, and the displacement distance of the regulation plate 44 can be measured by means of a graduation 241 of the slide block 24 such that the slats 12 can be cut in any required length.

By means of aforesaid design, because the first position is higher than the second position, the slide block 24 is located at the second position due to gravity when the blind cutter 10 of the present invention is unused, as shown in FIG. 4.

To cut the slats 12, a user can move the slide block 24 from the second position to the first position for enabling the saw blade 26 to cut the slats 12 that pass through the first through hole 201 of the base 20, as shown in FIG. 5. When the cutting action of the saw blade 26 is finished, the user can release the slide block 24 such that the slide block 24 can move back to the second position automatically due to gravity.

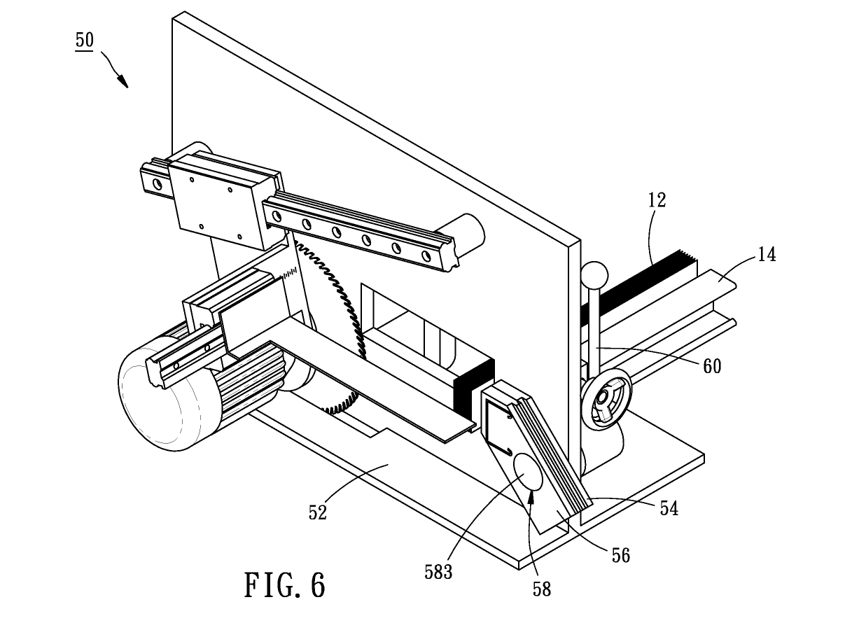

The way of relative movement between the fixed cutting blade and the moveable cutting blade may be changed. As shown in FIG. 6, a blind cutter 50 in accordance with a second preferred embodiment of the present invention comprises a moveable cutting blade 56 having an eccentric hole that is fitted to a cam portion 583 of a transmission rod 58 such that the movable cutting blade 56 and the transmission rod 58 can be rotated together, and a fixed cutting blade 54 being unmovable and unrotatable relative to the base 52 of the blind cutter 50. Therefore, when the user forces the transmission rod 58 to rotate through the handle 60, the head rail 14 of the blind can be cut by means of the relative rotation of the fixed cutting blade 54 and the movable cutting blade 56.

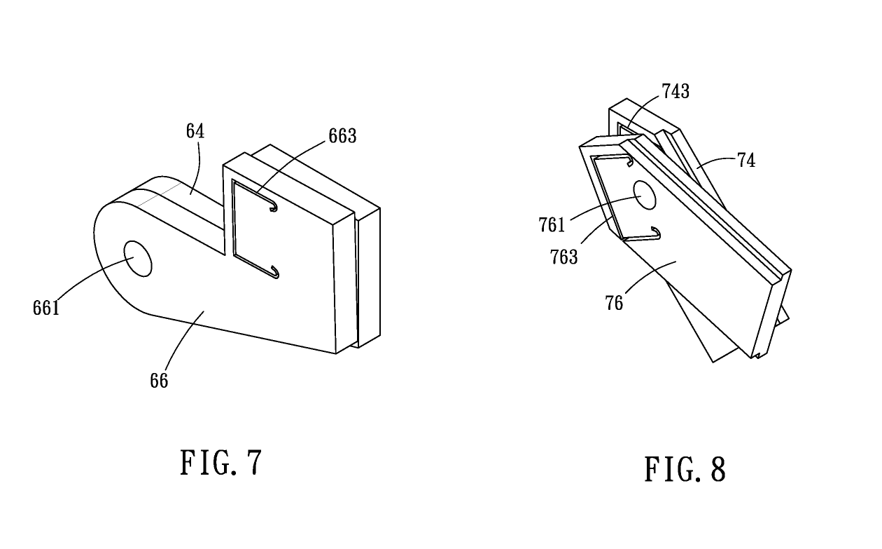

The shape of the fixed cutting blade and the movable cutting blade, and the position of the circular hole and the eccentric hole can be made with various kinds of design on the basis of the spirit of the present invention. As shown in FIG. 7, the eccentric hole 661 of the movable cutting blade 66 is located on the left of the cutting hole 663 of the movable cutting blade 66, and the circular hole (not shown) and the cutting hole (not shown) of the fixed cutting blade 64 are respectively communicated with the eccentric hole 661 and the cutting hole 663 of the movable cutting blade 66; and further, as shown in FIG. 8, the cutting hole 763 of the movable cutting blade 76 are located in the surrounding of the eccentric hole 761 of the movable cutting blade 76, and the circular hole (not shown) and the cutting hole 743 of the fixed cutting blade 74 are respectively communicated with the eccentric hole 761 and the cutting hole 763 of the movable cutting blade 76.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A blind cutter comprising:
a base having a first through hole and a second through hole;
a first rail mounted to said base;
a slide block slidably mounted to said first rail and being slidable between a first position and a second position, said first position being higher than said second position;
a saw blade rotatably connected with said slide block and covering said first through hole when said slide block is located at said first position;
a motor connected with said saw blade;
a fixed cutting blade fixed to said base; and
a movable cutting blade movably mounted to said base and abutted against said fixed cutting blade.

2. The blind cutter as claimed in claim 1, further comprising a regulation plate movably mounted to said slide block.

3. The blind cutter as claimed in claim 1, wherein said fixed cutting blade and said movable cutting blade are respectively provided with a cutting hole; said cutting holes are communicated with said second through hole of said base.

4. The blind cutter as claimed in claim 1, further comprising a transmission rod including a shaft portion inserted into a circular hole of said fixed cutting blade, and a cam portion inserted into an eccentric hole of said movable cutting blade.

5. The blind cutter as claimed in claim 4, wherein said cam portion of said transmission rod is fitted to said eccentric hole of said movable cutting blade such that said movable cutting blade can be forced to rotate by said transmission rod.

6. The blind cutter as claimed in claim 4, further comprising a handle connected with said shaft portion of said transmission rod.

7. The blind cutter as claimed in claim 1, further comprising a screw rotatably mounted to said base, and a clamp member engaged with said screw to be movable relative to said first through hole of said base.

8. The blind cutter as claimed in claim 1, wherein said fixed cutting blade and said movable cutting blade are clamped between two guide plates of a second rail.
